(19) United States
(12) Patent Application Publication
(10) Pub. No.: US 2024/0408830 A1
(43) Pub. Date: Dec. 12, 2024

(54) METHOD FOR MANUFACTURING PRESSURE ADJUSTMENT MECHANISM, PRESSURE ADJUSTMENT MECHANISM, AND PRINTING HEAD MECHANISM

(71) Applicant: CANON KABUSHIKI KAISHA, TOKYO (JP)

(72) Inventor: SATOSHI KUDO, TOKYO (JP)

(21) Appl. No.: 18/673,434

(22) Filed: May 24, 2024

(30) Foreign Application Priority Data
Jun. 9, 2023 (JP) 2023-095325

(51) Int. Cl. B29C 65/74; B29C 65/02; B29K 23/00; B29K 67/00; B29L 31/00; B41J 2/16; B41J 2/175

(52) U.S. Cl. CPC B29C 65/749; B29C 65/02; B41J 2/1623; B41J 2/175; B29K 2023/12; B29K 2067/003; B29L 2031/767

(57) ABSTRACT

A method for manufacturing a pressure adjustment mechanism having a film capable of being more easily molded than a conventional technique is provided. The method for manufacturing a pressure adjustment mechanism capable of adjusting a pressure of a liquid, comprises: preparing a main body in which an elastic body is disposed in a depressed portion, and a film having flexibility to which a plate member is fixed; welding the film to the main body in such a manner as to cover the depressed portion while contracting the elastic body by using the plate member; and molding the film by moving the plate member in a direction opposite to the depressed portion while sucking a portion to which the plate member is fixed in the film in a state where the film is fixed to the main body in the welding.

### FIELD OF THE DISCLOSURE

The present disclosure relates to a method for manufacturing a pressure adjustment mechanism, a pressure adjustment mechanism, a printing head mechanism, and a printing apparatus.

### DESCRIPTION OF THE RELATED ART

A mechanism for adjusting a pressure of a liquid to be supplied to an inkjet recording head or the like by utilizing a negative pressure has been known. Japanese Patent Laid-Open No. 2007-152842 discloses a liquid storage container capable of adjusting a pressure of a liquid, the liquid storage container including: a frame which has a depressed shape; a sheet which is welded to the frame and is deformable in accordance with an internal pressure; and a spring unit which is incorporated in the frame. Japanese Patent Laid-Open No. 2007-152842 also discloses that the spring unit includes a spring and a pressing plate. Hereinafter a “frame”, a “sheet”, a “liquid storage unit”, a “pressing plate”, and a “liquid storage container” are referred to respectively as a “main body”, a “film”, a “storing chamber”, a “plate member”, and a “pressure adjustment mechanism” as appropriate. According to the liquid storage container of Japanese Patent Laid-Open No. 2007-152842, supply of a liquid (for example, an ink) from a liquid storage unit to an external apparatus (for example, an inkjet recording head) is achieved by utilizing a negative pressure.

It is known that in general, oriented films are in a state of having already been extended and have larger rigidities than that of cast films. It is also known that oriented films are more excellent in mechanical properties such as gas permeability, chemical resistance, heat resistance, and tension strength than cast films.

However, in the manufacturing method of Japanese Patent Laid-Open No. 2007-152842, after the film is extended, in a case of molding the film such that the film can be deformed in accordance with an internal pressure, a large number of jigs (a heating device, a sucking frame, an assist jig, and the like) are needed.

In addition, in the manufacturing method of Japanese Patent Laid-Open No. 2007-152842, in a case where the film is molded into a protruding shape, the film is pushed up by only an elastic restoring force of a spring. Therefore, since a force to push up a film is insufficient, it can be difficult to uniformly mold the film. Moreover, in the manufacturing method of Japanese Patent Laid-Open No. 2007-152842, in the case of using a film having a larger rigidity than that of the film disclosed in Japanese Patent Laid-Open No. 2007-152842 as well, it can be difficult to mold the film into a protruding shape.

### SUMMARY

In view of this, an object of the present disclosure is to provide a method for manufacturing a pressure adjustment mechanism including a film capable of being more easily molded than the conventional technique.

The present disclosure is a method for manufacturing a pressure adjustment mechanism capable of adjusting a pressure of a liquid having: preparing a main body in which an elastic body is disposed in a depressed portion, and a film having flexibility to which a plate member is fixed; welding the film to the main body in such a manner as to cover the depressed portion while contracting the elastic body by using the plate member; and molding the film by moving the plate member in a direction opposite to the depressed portion while sucking a portion to which the plate member is fixed in the film in a state where the film is welded to the main body.

Further features of the present disclosure will become apparent from the following description of exemplary embodiments with reference to the attached drawings.

### BRIEF DESCRIPTION OF THE DRAWINGS

FIG. 1 is a schematic diagram of a printing apparatus applicable to one embodiment;

FIG. 2 is a schematic sectional view showing part of a pressure adjustment mechanism applicable to the one embodiment;

FIG. 3 is a schematic sectional view showing an example of a film applicable to the one embodiment;

FIG. 4 is a sectional view showing an example of a method for manufacturing a pressure adjustment mechanism in the one embodiment;

FIG. 5 is a sectional view showing an example of the method for manufacturing a pressure adjustment mechanism in the one embodiment;

FIG. 6 is a sectional view showing an example of the method for manufacturing a pressure adjustment mechanism in the one embodiment;

FIG. 7 is an enlarged view of a circle VII in FIG. 6;

FIG. 8 is a sectional view showing an example of the method for manufacturing a pressure adjustment mechanism in the one embodiment;

FIG. 9 is an enlarged view of a circle IX in FIG. 8;

FIG. 10 is a sectional view showing an example of the method for manufacturing a pressure adjustment mechanism in the one embodiment;

FIG. 11 is a schematic plan view showing an example of the pressure adjustment mechanism applicable to the one embodiment;

FIG. 12 is a sectional view showing an example of a method for manufacturing a pressure adjustment mechanism in one embodiment;

FIG. 13 is a sectional view showing an example of the method for manufacturing a pressure adjustment mechanism in the one embodiment;

FIG. 14 is a sectional view showing an example of the method for manufacturing a pressure adjustment mechanism in the one embodiment;

FIG. 15 is a sectional view showing an example of the method for manufacturing a pressure adjustment mechanism in the one embodiment;

FIG. 16 is a sectional view showing an example of the method for manufacturing a pressure adjustment mechanism in the one embodiment; and

FIG. 17 is a sectional view showing an example of the method for manufacturing a pressure adjustment mechanism in the one embodiment.

### DESCRIPTION OF THE EMBODIMENTS

### First Embodiment

In the present disclosure, “printing” does not mean only forming significant information (for example, a character, a figure, or the like visualized to be capable of being visually perceived by humans). “Printing” also means forming insignificant information. In the present disclosure, “printing” also means forming an image, a design, a pattern, a structure, or a combination of these, or the like on a printing medium, or also processing a medium.

### Printing Apparatus 100

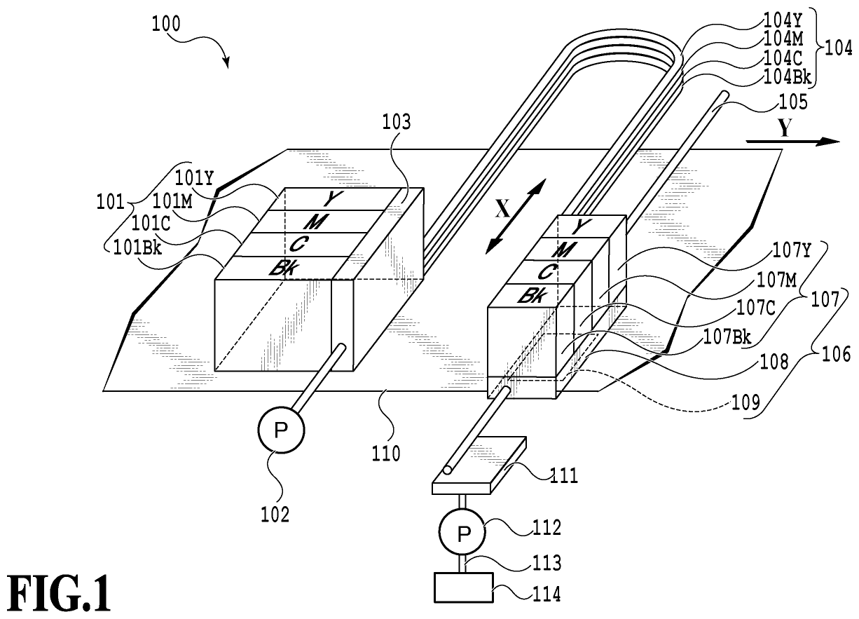

FIG. 1 is a schematic diagram of a printing apparatus 100 applicable to the present embodiment.

As shown in FIG. 1, the printing apparatus 100 includes a tank 101 capable of storing a liquid, a first pump 102 for pressurizing and supplying the liquid, and a connecting unit 103 to which the tank 101 can be connected. The present embodiment is described on the assumption that the printing apparatus 100 is an inkjet printing apparatus and the liquid is an ink. The printing apparatus 100 includes a tube 104 having flexibility, a guide shaft 105 disposed along a scanning direction (an X direction in the drawing), and a printing head mechanism 106 capable of conducting printing.

The printing head mechanism 106 includes a pressure adjustment mechanism 107 capable of adjusting a pressure inside in the case of conducting printing, a carriage 108 to and from which the pressure adjustment mechanism 107 can be attached and detached, and a printing head 109 disposed in the carriage 108.

The printing apparatus 100 includes a conveyance mechanism (not shown) for intermittently conveying a printing medium 110 in a conveyance direction (a Y-direction in the drawing) intersecting (in the present example, being orthogonal to) the scanning direction. In the present example, as an example of the printing medium 110, cut paper is used. The printing apparatus 100 includes a cap 111 capable of capping the printing head 109, a second pump 112 connected to the cap 111, a discharge pipe 113 capable of discharging an unnecessary liquid, and an absorber 114 capable of absorbing an unnecessary liquid.

In the present embodiment, the tank 101 is placed at a position away from the printing head mechanism 106. Note that in the case where the volume of the liquid stored in the tank 101 has become a predetermined value or less, it is possible to refill the tank 101 with the liquid from outside. Such a configuration makes it possible to increase a storable volume of a liquid more than a general tank that is disposed on a carriage.

In the present embodiment, the tank 101 includes a first tank 101Y, a second tank 101M, a third tank 101C, and a fourth tank 101Bk. In each of the first tank 101Y, the second tank 101M, the third tank 101C, and the fourth tank 101Bk, a liquid of a different type can be independently stored. For example, the first tank 101Y is capable of storing a yellow liquid. The second tank 101M is capable of storing a magenta liquid. The third tank 101C is capable of storing a cyan liquid. The fourth tank 101Bk is capable of storing a black liquid.

Hereinafter, in the case where there is no need to particularly distinguish the first tank 101Y, the second tank 101M, the third tank 101C, and the fourth tank 101Bk, these are simply called the “tank 101”.

The liquid is supplied from the tank 101 to the inside of the connecting unit 103. A proximal end of the tube 104 is connected to the connecting unit 103. A distal end of the tube 104 is connected to the pressure adjustment mechanism 107.

In the present embodiment, the tube 104 includes a first tube 104Y, a second tube 104M, a third tube 104C, and a fourth tube 104Bk. The first tube 104Y is capable of supplying the yellow liquid. The second tube 104M is capable of supplying the magenta liquid. The third tube 104C is capable of supplying the cyan liquid. The fourth tube 104Bk is capable of supplying the black liquid.

Hereinafter, in the case where there is no need to particularly distinguish the first tube 104Y, the second tube 104M, the third tube 104C, and the fourth tube 104Bk, these are simply called the “tube 104”.

In the case where the printing operation is conducted by the printing head mechanism 106, the first pump 102 is driven to pressurize and supply the liquid from the connecting unit 103 to the pressure adjustment mechanism 107 via the tube 104 independently for each of the above-mentioned four types. The printing medium 110 is intermittently conveyed by the conveyance mechanism (not shown). In the printing apparatus 100, the conveyance of the printing medium 110 and the printing by the printing head mechanism 106 moving in the scanning direction and ejecting the liquids onto the printing medium 110 are alternately conducted.

The pressure adjustment mechanism 107 is capable of introducing the liquid pressurized and supplied from the tube 104 into the inside of the pressure adjustment mechanism 107. The liquid introduced into the inside of the pressure adjustment mechanism 107 is supplied to the printing head 109 by the second pump 112 being suction-driven in a state where the cap 111 is abutted on the ejection port surface. The inside of the pressure adjustment mechanism 107 is caused to have a negative pressure by this suction pump sucking the liquid stored inside the pressure adjustment mechanism 107.

In the present embodiment, the pressure adjustment mechanism 107 includes a first pressure adjustment mechanism 107Y, a second pressure adjustment mechanism 107M, a third pressure adjustment mechanism 107C, and a fourth pressure adjustment mechanism 107Bk. The first pressure adjustment mechanism 107Y is capable of supplying the printing head 109 with the liquid supplied from the first tube 104Y. The second pressure adjustment mechanism 107M is capable of supplying the printing head 109 with the liquid supplied from the second tube 104M. The third pressure adjustment mechanism 107C is capable of supplying the printing head 109 with the liquid supplied from the third tube 104C. The fourth pressure adjustment mechanism 107Bk is capable of supplying the printing head 109 with the liquid supplied from the fourth tube 104Bk.

Hereinafter, in the case where there is no need to particularly distinguish the first pressure adjustment mechanism 107Y, the second pressure adjustment mechanism 107M, the third pressure adjustment mechanism 107C, and the fourth pressure adjustment mechanism 107Bk, these are simply called the “pressure adjustment mechanism 107”.

The pressure adjustment mechanism 107 and the printing head 109 are mounted on the carriage 108 capable of reciprocating along the guide shaft 105. The carriage 108 is capable of reciprocating in the scanning direction by using a drive force of a drive source (not shown). The printing head 109 includes a plurality of nozzles (not shown) capable of ejecting the liquids. The plurality of nozzles are arrayed such that a nozzle array corresponding to the liquid of each type among the above-mentioned four types is formed in the conveyance direction. Each nozzle in the plurality of nozzles can eject the liquid by using a thermoelectric conversion element (heater), a piezoelectric element, or the like. In the case where a thermoelectric converter is used, the liquid can be made into bubbles by the heat generation, and the liquid can be ejected as droplets from the ejection port of the distal end of the nozzle by utilizing the bubble generating energy.

Printing can be made on the printing medium 110 by alternately repeating a printing scan (scan) in which the printing head 109 ejects the liquid from the nozzles while moving together with the carriage 108 in the scanning direction and an operation of conveying the printing medium 110 in the conveyance direction. In this way, the printing apparatus 100 of the present embodiment functions as a so-called serial-scan-type printing apparatus. Therefore, according to the printing apparatus 100 of the present embodiment, the weight and size of the carriage 108 can be reduced as compared with a carriage that a general on-carriage-type printing apparatus includes.

In the case where the printing head 109 needs maintenance, the carriage 108 moves to above the cap 111. The cap 111 can move upward and downward by a drive source (not shown). The cap 111 moves upward at the time of maintenance to cap the ejection port surface in which the ejection ports are formed in the printing head 109. In a state where the ejection port surface is capped, the second pump 112 is capable of reducing the pressure inside the cap 111. The liquid remaining inside the printing head 109 can be discharged via the discharge pipe 113 by the second pump 112 reducing the pressure inside the cap 111. The liquid thus discharged is absorbed by the absorber 114 disposed in the apparatus main body.

In the present embodiment, initial filling of the printing head with the ink is conducted prior to the printing operation. Specifically, the pressurization and supply of the ink by the first pump 102 and sucking of the ink in which the second pump 112 is driven in the state where the cap 111 is abutted on the printing head 109 are conducted. This brings about a state where the liquid is stored also in the storing chamber (not shown here) of the pressure adjustment mechanism 107.

### Pressure Adjustment Mechanism 107

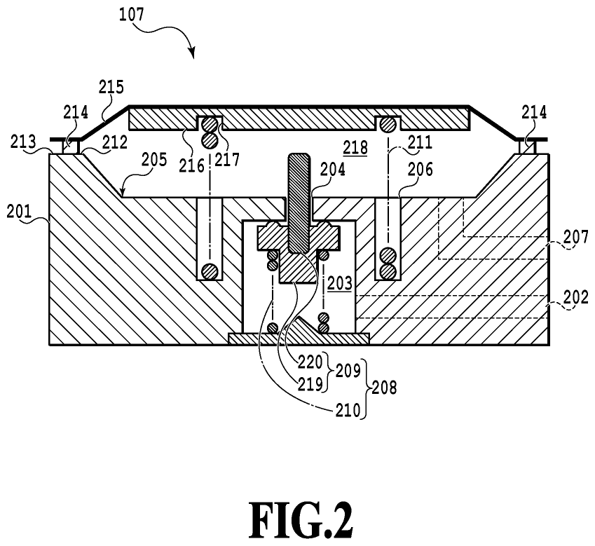

FIG. 2 is a schematic sectional view showing part of the inside in the pressure adjustment mechanism 107 in the present embodiment. As mentioned above, the present embodiment includes four pressure adjustment mechanisms 107. However, in FIG. 2, description is made by giving one pressure adjustment mechanism 107 as an example for convenience of description. The configurations of the four pressure adjustment mechanisms 107 used in the present embodiment are all the same except the type of the stored liquid.

As shown in FIG. 2, one pressure adjustment mechanism 107 includes one main body 201. In the main body 201, a valve chamber 203 is molded inside the main body 201, and a supply flow path 202 capable of supplying the liquid to the valve chamber 203 is molded. Moreover, in the main body 201, a depressed portion 205, a connection flow path 204 connecting the valve chamber 203 and the depressed portion 205, and a discharge flow path 207 capable of discharging the liquid from the depressed portion 205 are molded. In a bottom surface of the depressed portion 205, a first groove 206 in a ring shape (in the present example, a circular ring shape) is molded.

A material forming the main body 201 contains polypropylene (PP). The supply flow path 202 is molded to be capable of supplying the valve chamber 203 with the liquid supplied from the tube. In the valve chamber 203, a valve mechanism 208 is disposed. The valve mechanism 208 includes a valve 209 capable of opening and closing the connection flow path 204 and a first elastic body 210 (in the present example, a coil spring) capable of biasing the valve 209 in an upward direction in the drawing.

In the first groove 206, a proximal end portion of a second elastic body 211 (in the present example, a coil spring) is fitted. Note that the second elastic body 211 is not fixed to the first groove 206. A rib 214 is molded in such a manner as to protrude in a ring shape (in the present example, a cylindrical shape) from a peripheral portion 213 of an opening 212 of the depressed portion 205. To the rib 214, a film 215 having flexibility is fixed (in the present example, thermally welded).

In the present embodiment, part of the film 215 is capable of protruding from the top portion of the rib 214 by 0.9 millimeter or more toward a direction opposite to the direction in which the depressed portion 205 is depressed. It is particularly preferable that the rib 214 be configured to contain PP. It is preferable that a weld layer (described later) with the rib 214 in the film 215 also contain PP. By configuring the rib 214 and the weld layer of the film 215 by using the same material, these can be fused with each other at the same heating temperature.

To the weld layer of the film 215, a plate member 216 is fixed (in the present example, thermally welded). In the plate member 216, a second groove 217 in a ring shape is molded, into which a distal end portion of the second elastic body 211 can be fitted. Note that the second elastic body 211 is not fixed to the second groove 217. A storing chamber 218 capable of liquid-tightly storing the liquid is molded by fixing the film 215 to the rib 214 in such a manner as to cover the depressed portion 205.

The connection flow path 204 is molded in such a manner as to connect the storing chamber 218 and the valve chamber 203. The valve 209 includes a sealing member 219 for opening and closing the connection flow path 204 and a pin member 220 protruding from the sealing member 219. A proximal end portion of the pin member 220 is inserted into and fixed to an insertion portion of the sealing member 219. The valve 209 is disposed in the valve chamber 203 such that a distal end portion of the pin member 220 is passed from the sealing member 219 through the connection flow path 204 to enter the storing chamber 218.

At the time when the pressure adjustment mechanism 107 is manufactured, the plate member 216 does not abut on the pin member 220. This is because the second elastic body 211 which has a larger height than the height of the pin member 220 biases the depressed portion 205 and the plate member 216 in a direction away from each other (the upward direction in the drawing).

After the pressure adjustment mechanism 107 is mounted on the printing apparatus 100 as in FIG. 1, the first pump 102 is driven to fill the valve chamber 203 with the liquid. Driving the first pump 102 pressurizes the valve chamber 203. Hence, the valve 209 closes the connection flow path 204. Therefore, the liquid does not flow into the storing chamber 218.

Next, driving the second pump 112 causes a negative pressure to gradually increase inside the storing chamber 218. Once the negative pressure inside the storing chamber 218 reaches a predetermined value or more, the plate member 216 moves in a downward direction in the drawing against the bias of the second elastic body 211 in such a manner as to contract the capacity of the storing chamber 218. Thereafter, the plate member 216 abuts on the distal end portion of the pin member 220, and as the pin member 220 moves in the downward direction in the drawing, the connection flow path 204 is opened. Opening the connection flow path 204 allows the liquid in the valve chamber 203 to flow into the storing chamber 218.

As the liquid flows into the pressure adjustment mechanism 107 and the printing head 109 in this way, the negative pressure in the storing chamber 218 gradually decreases. Along with the decrease of the negative pressure in the storing chamber 218, the plate member 216 gradually moves in the upward direction in the drawing. Then, the capacity of the storing chamber 218 is stabilized in a state where the negative pressure in the storing chamber 218 and the counter force of the second elastic body 211 are balanced.

In this state, once the printing operation is started, the liquid is supplied from the storing chamber 218 to the printing head via the discharge flow path 207. This causes the storing chamber 218 to have a more negative pressure. This generation of the negative pressure moves the plate member 216 in the downward direction in the drawing to cause the film 215 to further deflect, so that the pin member 220 is pressed by the plate member 216 to open the connection flow path 204. Opening the connection flow path 204 allows the storing chamber 218 to be refilled with the liquid from the valve chamber 203.

Once the storing chamber 218 is refilled with the liquid and the negative pressure inside the storing chamber 218 decreases, the plate member 216 is lifted by an elastic restoring force of the second elastic body 211. Lifting the plate member 216 also causes the shape of the film 215 to return to a protruding shape. While the plate member 216 is being lifted, the valve 209 is lifted by an elastic restoring force of the first elastic body 210. This causes the connection flow path 204 to be sealed again by the sealing member 219. Note that at this time, the pin member 220 and the plate member 216 are in a state of abutting on each other.

In this way, in the pressure adjustment mechanism 107, the valve 209 opens and closes the connection flow path 204 with the consumption of the ink in the printing head 109 and the supply of the ink from the valve chamber 203. Such an opening and closing operation of the valve 209 makes it possible to stabilize the liquid to be supplied to the printing head 109 within a predetermined pressure range.

In addition, the material of the film 215 is required to have durability for enduring repetition of deformation associated with upward and downward movement of the plate member 216, gas barrier properties, water vapor barrier properties, and long-term preservability for preserving the liquid for a relatively long period of time.

### Film 215

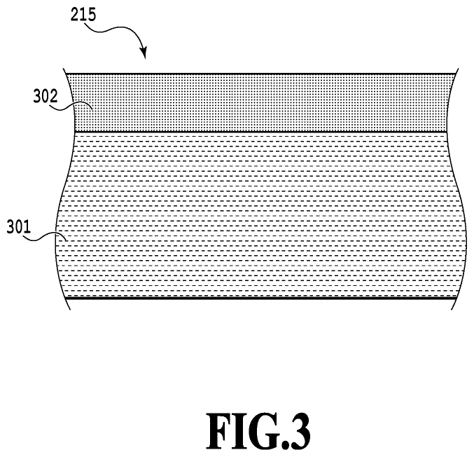

FIG. 3 is a sectional view showing an example of the film 215 applicable to the present embodiment.

As shown in FIG. 3, the film 215 includes a weld layer 301 (first layer) which is extendable and a base film layer 302 (second layer) which is difficult to extend. Specifically, the weld layer 301 contains PP. The base film layer 302 contains polyethylene terephthalate (PET). In the present embodiment, the base film layer 302 is laminated on the weld layer 301. More specifically, the weld layer 301 is a cast polypropylene film formed of cast polypropylene (CPP). The base film layer 302 is an oriented polyethylene terephthalate film (oriented PET film) formed of oriented PET.

To further improve the gas barrier properties and the water vapor barrier properties which the base film layer 302 has, aluminum or silica may be deposited on the base film layer 302. As long as the film 215 has the above-mentioned gas barrier properties, water vapor barrier properties, durability, and long-term preservability, the film 215 may include a layer containing a material other than the above materials.

### Steps for Manufacturing Pressure Adjustment Mechanism

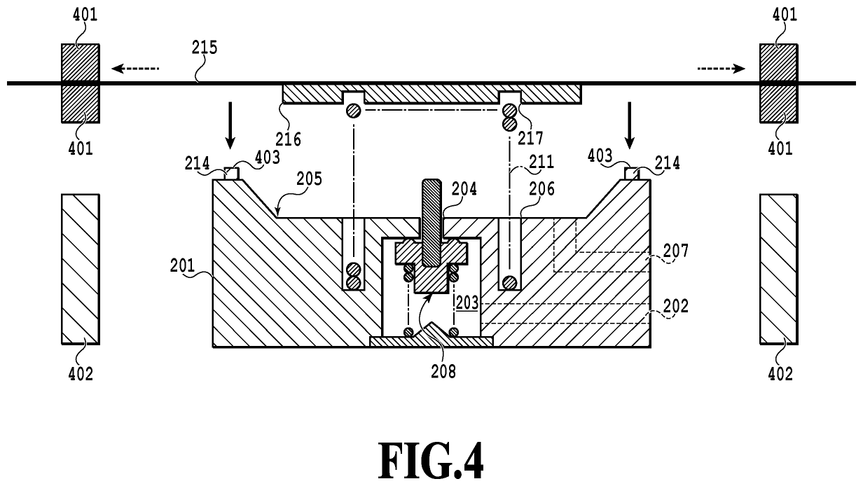

A method for manufacturing a pressure adjustment mechanism of the present embodiment will be described with reference to FIG. 4 to FIG. 11. FIG. 4 to FIG. 10 are schematic sectional views of a pressure adjustment mechanism in the respective steps of the manufacturing method of the present embodiment.

First, the main body 201 including the supply flow path 202, the valve chamber 203, the connection flow path 204, the first groove 206, the depressed portion 205, the rib 214, the valve mechanism 208, and the second elastic body 211 is prepared. Moreover, the film 215 having the weld layer to which the plate member 216 is thermally welded is prepared. Next, a holding jig 401 is caused to hold the film 215 above the main body 201 while laterally pulling the film 215. Below the holding jig 401, a coupling jig 402 capable of being positioned with and coupled to the holding jig 401 is disposed.

Next, an abutting step is conducted. In the abutting step, as shown in FIG. 4, the holding jig 401 is moved downward to abut the weld layer of the film 215 pulled in the lateral direction in the drawing on a top portion 403 of the rib 214. By pulling the film 215, a tension is generated in the film 215. This makes it possible to prevent the film 215 from being abutted on the main body 201 in a state of being deflected.

Specifically, at a position away from the main body 201, the holding jig 401 is caused to hold the film 215 while pulling the film 215 such that the weld layer of the film 215 and the top portion 403 of the rib 214 face each other. Then, while positioning is conducted in such a manner as to cause the position of the holding jig 401 and the position of the coupling jig 402 to coincide, the film 215 is brought closer to the main body 201, so that the distal end portion of the second elastic body 211 is fitted into the second groove 217. In a state where the distal end portion of the second elastic body 211 is fitted in the second groove 217, as the film 215 is brought even closer to the main body 201, the weld layer of the film 215 comes into tight contact with the top portion 403. In this way, in the abutting step, the film 215 is brought into tight contact with the rib 214 in such a manner as to cover the depressed portion 205 while contracting the second elastic body 211 with the plate member 216 by using the holding jig 401 and the coupling jig 402. Once the abutting step as described above is completed, next, a sucking step is conducted.

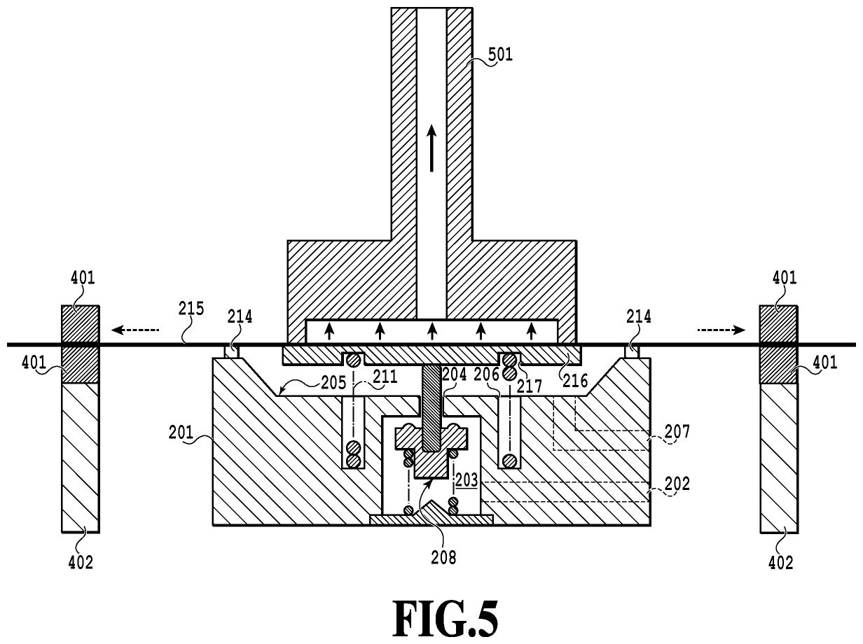

FIG. 5 is a diagram showing an example of the sucking step of sucking the film 215 in the present embodiment. The sucking step is conducted to prevent the film 215 from being displaced.

As shown in FIG. 5, in the sucking step, a weld portion between the film 215 and the plate member 216 is sucked by using a sucking jig 501. The weld portion between the film 215 and the plate member 216 has a larger rigidity and is smoother than a portion where the plate member 216 is not welded to the film 215. By sucking a portion which has a large rigidity and is smooth in this way, it is possible to generate a sufficient sucking force while preventing the film 215 from being displaced as compared with a case of sucking a portion which has a small rigidity and is not smooth. This increases a frictional force at an abutment portion between the sucking jig 501 and the film 215 to facilitate the works in steps following the sucking step. In a state where the weld portion is sucked in the sucking step, a welding step is conducted.

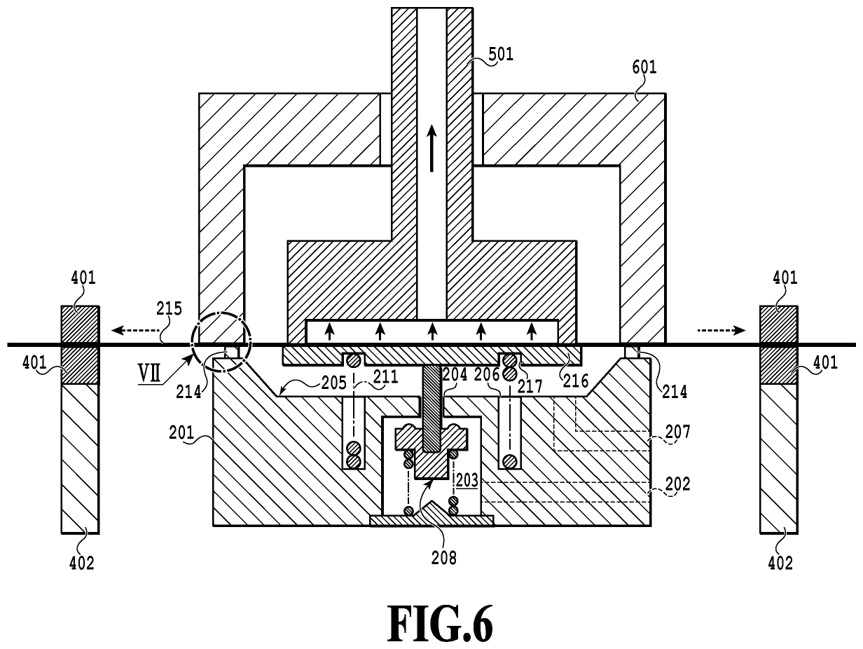

FIG. 6 is a diagram showing an example of the welding step of welding the main body 201 and the film 215 in the present embodiment.

As shown in FIG. 6, in the welding step, the abutment portion between the rib 214 and the film 215 is thermally welded by using a heating jig 601. In this way, in the welding step, the weld layer of the film 215 is welded to the rib 214 in such a manner as to cover the depressed portion 205 in a state where the second elastic body 211 is contracted with the plate member 216. Note that in the welding step as well, the sucking jig 501 is in the state of sucking the plate member 216 via the film 215.

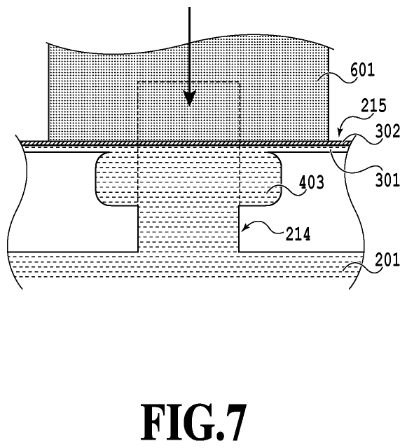

FIG. 7 is an enlarged view of a region surrounded by a circle VII of FIG. 6.

As shown in FIG. 7, the rib 214 is crushed while being melted by the heating jig 601 via the film 215. Note that a dashed line of FIG. 7 indicates the shape of the rib 214 before the rib 214 is crushed by the heating jig 601. The weld layer 301 and the top portion 403 of the rib 214 are fused with each other by the heating jig 601 heating and crushing the rib 214 from above the base film layer 302 in this way.

As mentioned above, the material of the main body 201 (particularly, the rib 214) is PP. That is, the material of the top portion 403 is the same as the material of the weld layer 301. In addition, it is known that the melting point of PET is sufficiently higher than the melting point of PP. Therefore, there is a low possibility that the base film layer 302 is melted while the weld layer 301 and the rib 214 are thermally welded. Since such a welding method can maintain a sufficient temperature margin in the case of thermally welding the weld layer 301 and the top portion 403, it is possible to achieve favorable thermal welding. After the thermal welding is completed, the heating jig 601 is retreated. Once the welding step as described above is completed, next, a molding step is conducted.

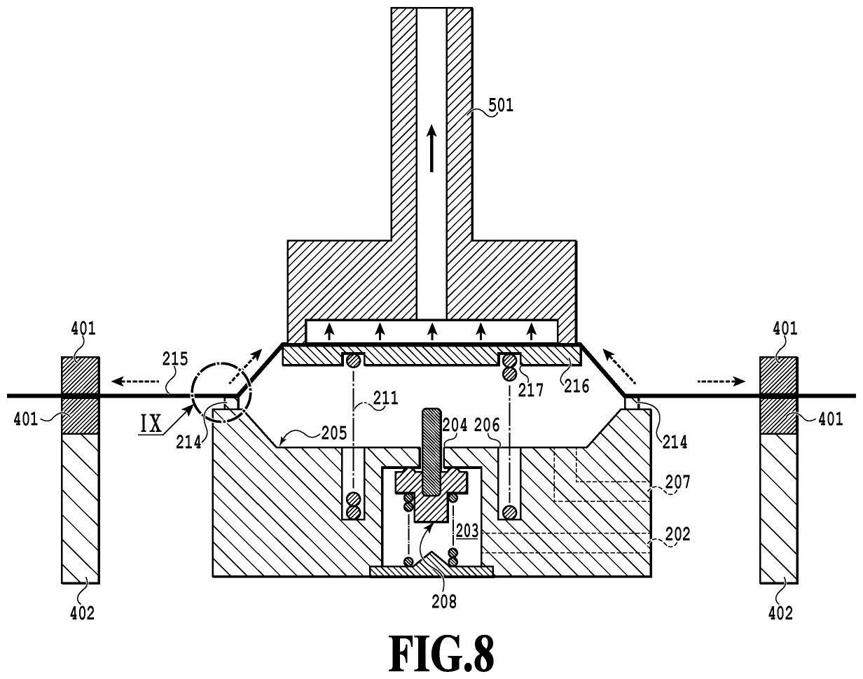

FIG. 8 is a diagram showing an example of the molding step of molding a protruding portion in the film 215 in the present embodiment.

As shown in FIG. 8, in the molding step, the sucking jig 501 is moved upward in the state where the film 215 is sucked by the sucking jig 501. In this way, in the molding step, the plate member 216 is moved together with the film 215 while the film 215 is sucked by the sucking jig 501 to mold, in the film 215, a protruding portion which protrudes toward the direction opposite to the direction in which the depressed portion 205 is depressed. Specifically, the sucking jig 501 is moved upward to such a position that a distance from the weld portion with the rib 214 to the weld portion with the plate member 216 in the film 215 becomes a predetermined distance. In the present embodiment, the weld portion with the plate member 216 in the film 215 is moved from the top portion of the rib 214 by about 0.9 mm by the sucking jig 501.

Specifically, the surface facing in the direction opposite to the direction in which the surface to which the plate member 216 is fixed faces in the film 215 is sucked by the sucking jig 501. Then, the sucking jig 501 is gradually moved upward such that the state in which the plate member 216 and the bottom surface of the depressed portion 205 are parallel with each other is maintained. In this way, a protruding portion which protrudes from the top portion of the rib 214 by about 0.9 mm can be molded in the film 215.

In the present embodiment, in molding a protruding portion in the film 215, the plate member 216 is not pressed upward with only the elastic restoring force of the second elastic body 211, but the film 215 is lifted by moving the sucking jig 501 upward. In the molding step, the elastic restoring force of the second elastic body 211 also acts on the film 215 via the plate member 216. Most of the force necessary for molding a protruding portion in the film 215 is generated by the upward movement of the sucking jig 501.

As a result, a protruding portion is molded in the film 215 regardless of the elastic restoring force of the second elastic body 211. That is, even in the case where the elastic restoring force of the second elastic body 211 is relatively small, a protruding portion can be molded in the film 215. Moreover, even in the case where the rigidity of the film 215 is relatively large, a protruding portion can be molded in the film 215.

In the present embodiment, the plate member 216 is fixed to the film 215 in advance, and the film 215 is lifted together with the plate member 216 by the sucking jig 501. As mentioned above, while the film 215 is being lifted, the state where the plate member 216 and the bottom surface of the depressed portion 205 are parallel with each other is maintained. Therefore, a protruding portion can be molded in the film 215 such that the plate member 216 does not incline relative to the bottom surface of the depressed portion 205, and no wrinkle is generated in the protruding portion of the film 215.

If the plate member 216 has inclined relative to the bottom surface of the depressed portion 205 or a wrinkle has been generated in the film 215, an extra force is required in the case of elastically deforming the film 215. According to the method for molding a protruding portion in the present embodiment, inclination of the plate member 216 and generation of a wrinkle in the protruding portion of the film 215 are suppressed. This makes it possible to smoothly elastically deform the film 215 at the time of printing operation.

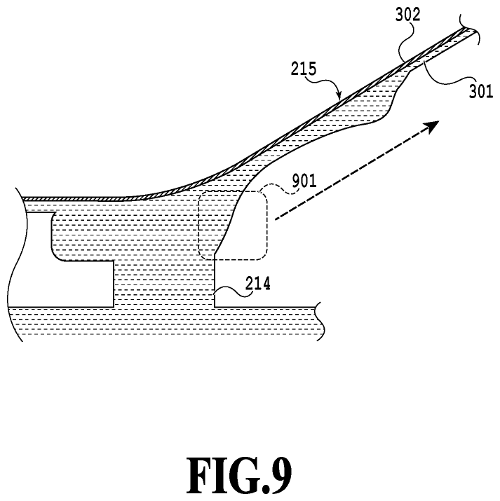

FIG. 9 is an enlarged view of a region surrounded by a circle IX of FIG. 8. A dashed line region 901 of FIG. 9 indicates a region which was part of the rib 214 before the rib 214 and the film 215 are thermally welded. A melted portion in the rib 214 is extended in such a manner as to follow the lifted film 215 due to the capillary action and the viscosity which melted PP has.

As shown in FIG. 9, the film 215 has a fixed portion which is fixed and a movable portion which is deformable. The fixed portion of the film 215 is a portion fixed to the rib 214 by fusing the weld layer 301 (cast film) and the rib 214 with each other. The movable portion is a portion at which the film 215 is capable of moving in a direction in which the depressed portion 205 (not shown here) is depressed and in a direction opposite to the direction in which the depressed portion 205 is depressed. In the present embodiment, the film 215 is capable of protruding from the top portion of the rib 214 by about 0.9 mm toward the direction opposite to the direction in which the depressed portion 205 is depressed.

The weld layer 301 is melted by heating of the heating jig. On the other hand, the base film layer 302 is not melted by heating of the heating jig. As mentioned above, this is because the melting point of the base film layer 302 is higher than the melting point of the weld layer 301. The fused portion of the weld layer 301 with the rib 214 is firmly supported by the melted rib 214 as compared with a portion to which the melted rib 214 has not adhered.

In the present embodiment, the weld layer 301 is a cast polypropylene film and the base film layer 302 is an oriented PET film. Therefore, since the base film layer 302 is in the state of having already been extended, the base film layer 302 cannot be longer than the original length. On the other hand, since the weld layer 301 is in the state of being capable of being extended, the weld layer 301 can be longer than the original length by being forcefully lifted by the upward movement of the sucking jig.

In this way, in the molding step, the weld layer 301 is lifted while being extended by the upward movement of the sucking jig, and the base film layer 302 is lifted together with the weld layer 301 by the sucking jig without being extended. According to such a method for molding a protruding portion, a protruding portion can be molded in the film 215 even in a case where the film 215 includes an oriented PET film. Once the molding step as described above is completed, next, a cooling step is conducted.

In the cooling step, the film 215 is held for a certain period of time while the protruding portion molded in the molding step is maintained. Then, heat escapes from the film 215 to the atmosphere. That is, in the cooling step of the present embodiment, the film 215 is naturally cooled. However, in the cooling step, cold air may be applied to the film 215. By applying cold air, time required for cooling can be shortened. Once the film 215 is cooled and fixed to the rib 214, a removing step of removing an unnecessary portion of the film 215 is conducted.

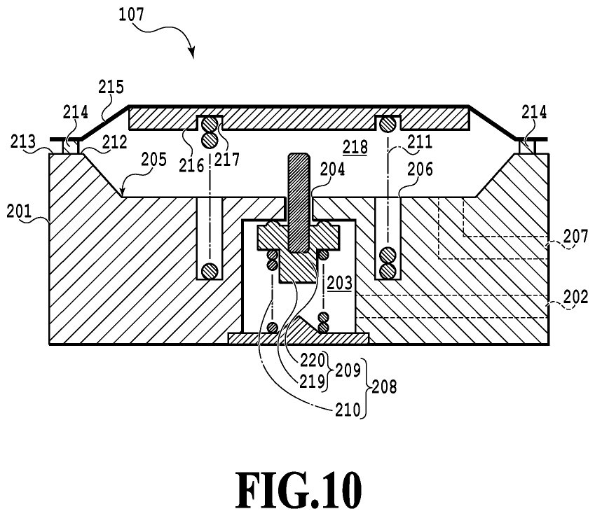

FIG. 10 is a diagram showing the pressure adjustment mechanism 107 after the removing step is conducted in the present embodiment.

In the removing step, an unnecessary portion (a portion sticking out from the main body 201) in the film 215 is removed (for example, cut) by using removing units (for example, a blade, a laser, or the like).

Through the above-mentioned manufacturing steps, the pressure adjustment mechanism 107 can be manufactured. Note that from the time when the pressure adjustment mechanism 107 is completed to the time when the inside of the storing chamber 218 becomes a negative pressure, the height of the protruding portion in the film 215 does not change.

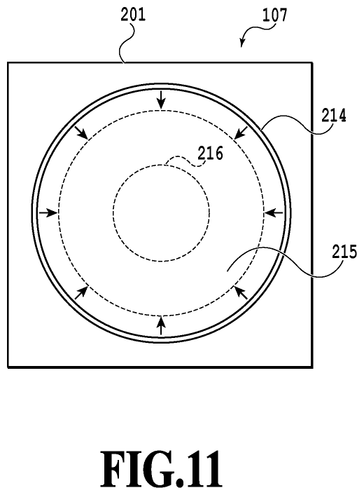

FIG. 11 is a schematic plan view of the completed pressure adjustment mechanism 107 in a case of being viewed from the film 215 side.

As shown in FIG. 11, the shape of the plate member 216 in the plane is a circular shape. Specifically, the shape of the plate member 216 in the present embodiment is a relatively thin circular plate shape. The film 215 to which the plate member 216 is thermally welded is molded by using a relatively transparent material. Hence, it is possible to see the rib 214 fused with the weld layer through the surface on which the base film layer is disposed.

In addition, the rib 214 is molded in a ring shape (in the present example, a circular ring shape) on a peripheral edge of the depressed portion 205 (not shown here). The size of the radius of the circular ring formed by the rib 214 disposed in a circular ring shape is larger than the size of the radius the circular shape of the plate member 216 in the plane. Moreover, in the welding step and the molding step, the respective works are conducted such that the center of the circular ring (ring) formed by the rib 214 disposed in a circular ring shape and the center of the circular shape of the plate member 216 in the plane coincide on the same axis. Hence, the distance from the plate member 216 to the rib 214 is constant in a circumferential direction. Therefore, the second elastic body 211 (not shown here) is stably extended and contracted, making it possible to apply a uniform tension to the film 215. As a result, in the step of molding a protruding portion in the film 215, generation of a wrinkle in the film 215 can be suppressed.

As described above, in the manufacturing method of the present embodiment, the film 215 is lifted by not only relying just on the elastic restoring force of the second elastic body 211 but also using the sucking jig in the case of molding a protruding portion in the film 215.

Hence, according to the manufacturing method of the present embodiment, a pressure adjustment mechanism having a film which can be molded more easily than the conventional technique can be manufactured. Moreover, according to the manufacturing method of the present embodiment, even in a case where a spring having a smaller elastic restoring force than the elastic restoring force which a spring of the conventional technique has is used, a smooth protruding portion can be molded in a film irrespective of the elastic restoring force of the spring. Moreover, according to the manufacturing method of the present embodiment, a film having a larger rigidity than the rigidity which the film of the conventional technique has can also be handled. Moreover, according to the manufacturing method of the present embodiment, a protruding portion can be molded in a film with high precision while generation of a wrinkle is suppressed as compared with the manufacturing method of the conventional technique.

### Second Embodiment

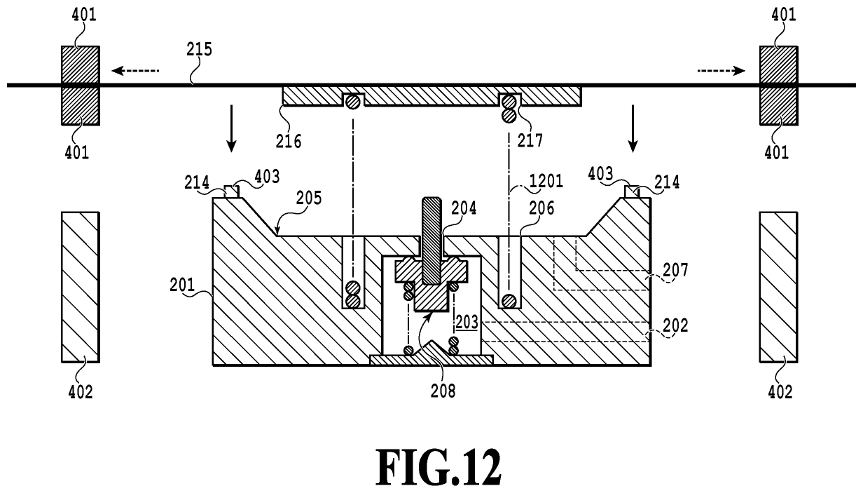

Hereinafter, a second embodiment in the technique of the present disclosure will be described with reference to FIG. 12 to FIG. 17. A difference between the manufacturing method in the first embodiment and the manufacturing method in the present embodiment is the presence or absence of a pushing step of pushing the film.

In the present embodiment, for the film is pushed and extended to the inner side of the depressed portion, the height of the protruding portion is larger than that in the first embodiment. This also makes the height of the storing chamber higher than that in the first embodiment. For the height of the storing chamber becomes higher, an elastic member which is longer than that in the first embodiment is used in the present embodiment. In the following description, configurations similar or corresponding to those in the first embodiment will be denoted by the same signs and the descriptions thereof will be omitted, and different points will be mainly described.

In the preparing step, a main body 201 including a supply flow path 202, a valve chamber 203, a connection flow path 204, a first groove 206, a depressed portion 205, a rib 214, a valve mechanism 208, and a third spring 1201 (see FIG. 12) is prepared. In the present embodiment, the length of the third spring 1201 is larger than the length of the second elastic body 211 (see FIG. 2 and the like). A proximal end portion of the third spring 1201 is disposed in the first groove 206.

FIG. 12 is a diagram showing an example of an abutting step of abutting a film 215 to the main body 201 in the present embodiment.

As shown in FIG. 12, in the abutting step, a weld layer of the film 215 is abutted on a top portion 403 of the rib 214 in a state where the film 215 is held while being pulled to an outer side of the main body 201 by using a holding jig 401.

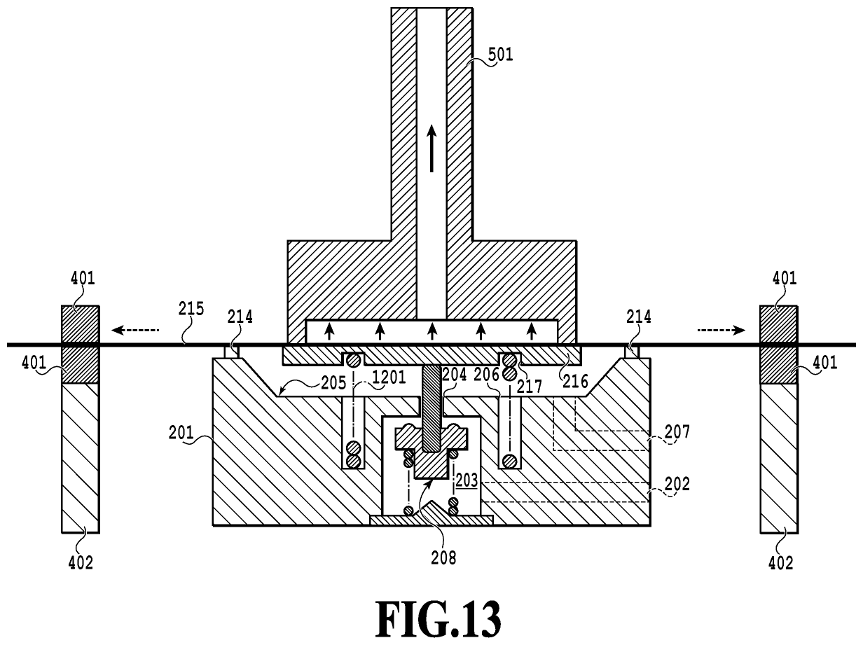

FIG. 13 is a diagram showing an example of a sucking step of sucking the film 215 in the present embodiment.

As shown in FIG. 13, in the sucking step, a weld portion between the film 215 and the plate member 216 is sucked by using a sucking jig 501. In the present embodiment, after the sucking step, the pushing step of pushing the film 215 in a direction of the depressed portion is conducted.

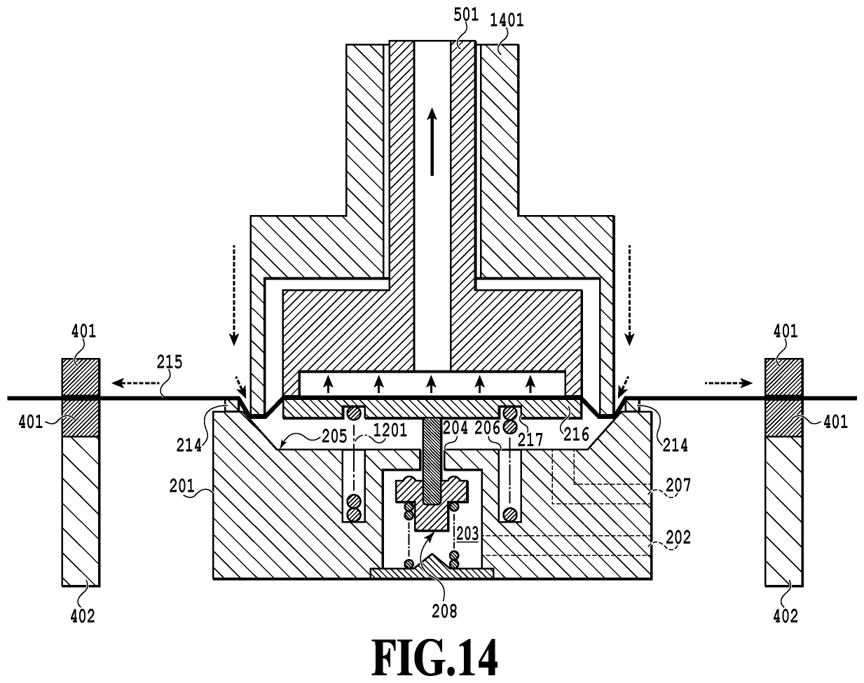

FIG. 14 is a diagram showing an example of the pushing step in the present embodiment.

As shown in FIG. 14, in the pushing step, the film 215 is pushed toward a bottom surface of the depressed portion 205 by using a pushing jig 1401. The amount of pushing the film 215 can be set as appropriate.

In the pushing step, a region in the film 215 between the rib 214 and the sucking jig 501 is pushed to extend the film 215 by using the pushing jig 1401. For the film 215 is pushed, the height of a protruding portion in the film 215 can be made larger than the height of the protruding portion in the first embodiment.

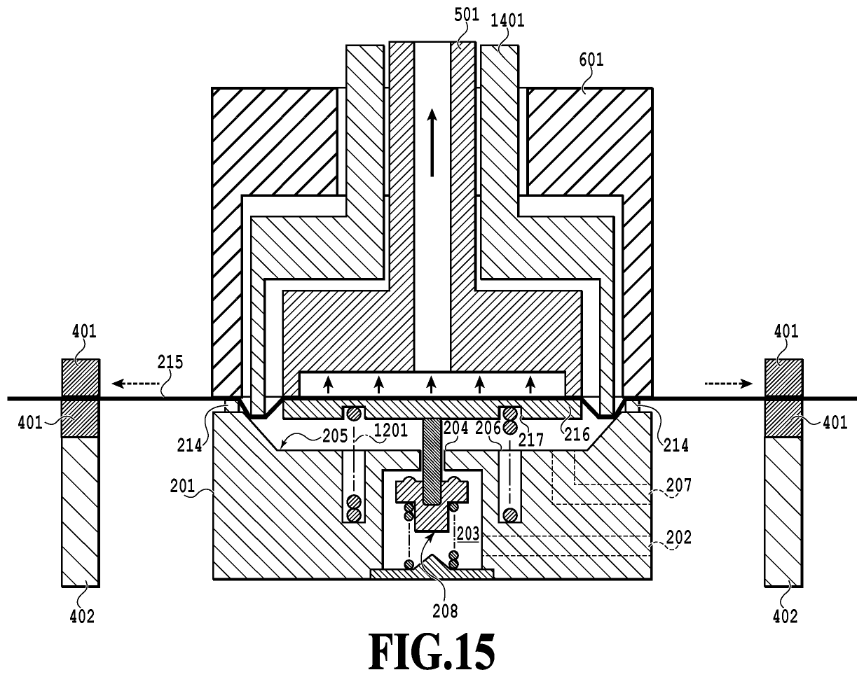

FIG. 15 is a diagram showing an example of a welding step of welding the main body 201 and the film 215 in the present embodiment.

As shown in FIG. 15, in the welding step, an abutment portion between the rib 214 and the film 215 is thermally welded by using a heating jig 601. Note that in the present step as well, the sucking jig 501 is in the state of sucking the film 215. The pushing jig 1401 is in the state of pushing the film 215. Once the welding step is completed, the heating jig 601 and the pushing jig 1401 are retreated from the main body.

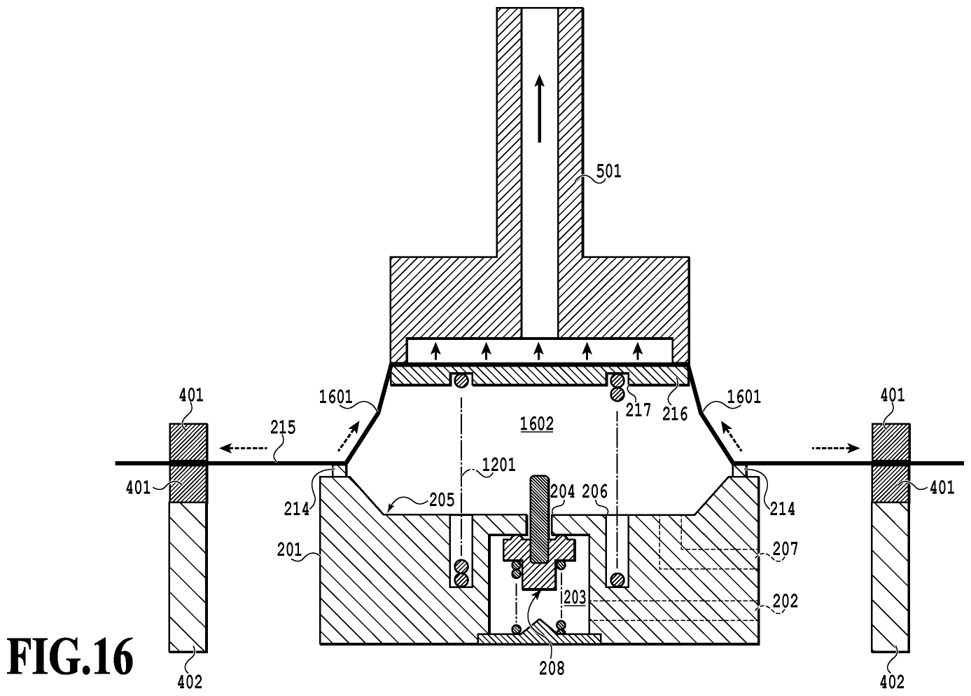

FIG. 16 is a diagram showing an example of a molding step of molding a protruding portion in the film 215 in the present embodiment.

As shown in FIG. 16, in the molding step, the sucking jig 501 is moved upward to a desired height in a state of sucking the film 215.

The film 215 in the present embodiment has a pressed portion 1601 pushed and extended by the pushing jig. In this way, in the film 215, a deflected portion in a ring shape which surrounds the plate member 216 is formed inward of the weld portion where the film 215 and the rib 214 have been welded and outward of the plate member 216. This makes it possible to make the height of the protruding portion in the film 215 higher than that in the first embodiment. That is, the volume of the storing chamber 1602 can be made larger than that in the first embodiment. In the present embodiment, the weld portion between the film 215 and the plate member 216 can be moved from the top portion of the rib 214 by about 1.8 mm.

As mentioned above, in the present embodiment, the third spring 1201 having a larger length than the second elastic body used in the first embodiment is used. This makes it possible, in the present step, to make the height of the storing chamber 1602 larger than the storing chamber in the first embodiment.

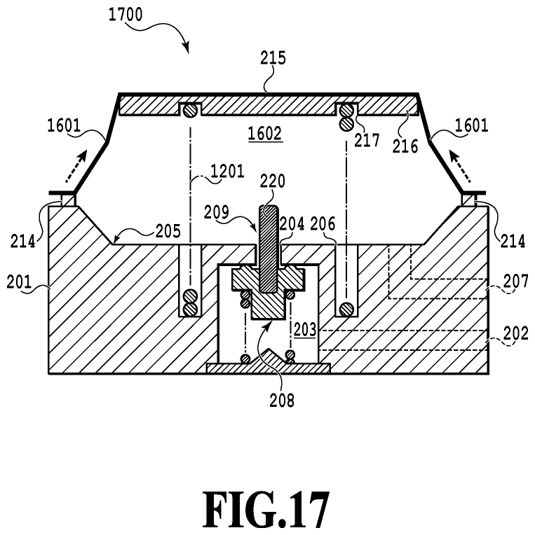

FIG. 17 is a diagram showing the pressure adjustment mechanism 107 after a removing step of removing an unnecessary portion of the film 215 in the present embodiment is conducted.

As shown in FIG. 17, an unnecessary portion (not shown) in the film 215 has been cut and removed by a laser or the like.

Through the above-mentioned manufacturing steps, the pressure adjustment mechanism 1700 in the present embodiment can be manufactured.

As described above, according to the manufacturing method of the present embodiment, the film is pushed by the pushing jig. This causes the film to be extended more than in the first embodiment, and increases a region of a deformable portion in the film. Therefore, in the present embodiment, in the case of molding a protruding portion in the film, the height of the protruding portion can be made larger than that in the first embodiment. As a result, the amount of deformation of the film in the case where the capacity of the storing chamber decreases in the present embodiment also increases more than the amount of deformation of the film in the case where the capacity of the storing chamber decreases in the first embodiment.

As mentioned above, while a predetermined negative pressure is maintained, the connection flow path is closed by the valve. In a case where a predetermined amount or more of the ink is consumed by the printing operation or the sucking operation by the second pump is conducted, the valve can open and close the connection flow path with favorable responsiveness to an increase in negative pressure.

In a case where a protruding portion is molded in a state where the amount of deflection of the film is relatively small, not only the lower surface of the plate member but also an inclined surface portion in the film from an end portion of the plate to the rib is influenced by the negative pressure. Hence, the internal pressure of the storing chamber is caused to easily vary, and the opening and closing operation of the valve is also destabilized. As in the present embodiment, in the case where the film is deflected to such an extent that a folded portion is generated on an inner side of the film, an influence of the negative pressure which the entire film receives can be concentrated on the lower surface (surface facing the depressed portion) of the plate member. Hence, it becomes possible to properly conduct the opening and closing operation of the valve associated with a change in the internal pressure of the storing chamber.

In addition, by making the amount of deflection of the film larger than that in the first embodiment, the capacity of the storing chamber can be made larger than that in the first embodiment. An increase in the capacity of the storing chamber increases a volume of bubbles which can be trapped during a printing operation as the bubbles are generated in the printing head. This makes it possible to increase the time for which continuous printing can be conducted more than in the first embodiment.

In addition, by nature, a storing chamber functions as a buffer chamber in a case where a film is deflected by an influence of the atmosphere. By increasing the capacity of the storing chamber more than in the first embodiment, the function which the storing chamber has as a buffer chamber can also be reinforced more than in the first embodiment.

Therefore, according to the method for manufacturing a pressure adjustment mechanism in the present embodiment, a protruding portion which is larger than that in the first embodiment can be molded in a film. Moreover, according to the pressure adjustment mechanism in the present embodiment, reliability in pressure adjustment at the time of printing operation can also be improved more than the conventional technique.

### Other Embodiments

In the first and second embodiments, the ink is given as an example of the liquid. Other examples of the liquid to which the technique of the present disclosure is applicable include various printing liquids including treatment liquids and the like to be used to aim at improving the fixability of an ink on a printing medium, reducing gloss unevenness, improving scratch resistance, and the like.

In the first and second embodiments, inks of four colors are used. However, in the technique of the present disclosure, the types of usable liquids are not limited to the above-mentioned inks of four colors. Inks of three colors or more and five colors or less including a color other than the above-mentioned four colors may be used.

In the first and second embodiments, cut paper is given as an example of the printing medium. Other examples of the printing medium include printing mediums of various materials and forms such as roll paper, cloth, an optical disk label face, a plastic sheet, an OHP sheet, an envelope, and the like.

In the first and second embodiments, a so-called serial-scan-type printing apparatus which conducts printing by reciprocating a printing head mechanism and intermittently conveying a printing medium is illustrated. However, the printing apparatus to which the technique of the present disclosure is applicable is not limited to this example. The technique of the present disclosure is applicable to a so-called full-line-type printing apparatus which conducts printing on a continuously conveyed printing medium by using a long printing head in which ejection ports are provided in a region corresponding to the width of the printing medium.

In the first and second embodiments, it is possible to refill the tank with the liquid from outside. However, an example of a tank to which the technique of the present disclosure is applicable is not limited to this. The technique of the present disclosure is also applicable in a case where a tank of system in which in a case where a liquid in a cartridge is used up, the cartridge can be replaced with a new cartridge filled with the liquid.

In the first and second embodiments, a so-called, off-carriage-type printing apparatus in which a tank is placed at a position away from a printing head mechanism is illustrated. The technique of the present disclosure is applicable also to a so-called, on-carriage-type printing apparatus in which a cartridge filled with a liquid is mounted on a carriage.

In the first and second embodiments, the pressure adjustment mechanism is configured to be mounted on a carriage and move together with a printing head. However, a form to which the technique of the present disclosure is applicable is not limited to such a form. The pressure adjustment mechanism may be fixed inside a main body of a printing apparatus separately from a carriage and a printing head.

In the first and second embodiments, as the material of the base film layer, an oriented PET film having a larger rigidity than that of the sheet of the conventional technique is used. As another example of the material for forming the base film layer, a film having a smaller rigidity than that of an oriented PET film may be used. Even in the case of using a film which can be relatively easily extended, the technique of the present disclosure is applicable.

The method for manufacturing a pressure adjustment mechanism in the present disclosure makes it possible to mold a protruding portion in a film more easily than the conventional technique.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-095325, filed Jun. 9, 2023, which is hereby incorporated by reference wherein in its entirety.

What is claimed is:

1. A method for manufacturing a pressure adjustment mechanism capable of adjusting a pressure of a liquid, comprising:
preparing a main body in which an elastic body is disposed in a depressed portion, and a film having flexibility to which a plate member is fixed;
welding the film to the main body in such a manner as to cover the depressed portion while contracting the elastic body by using the plate member; and
molding the film by moving the plate member in a direction opposite to the depressed portion while sucking a portion to which the plate member is fixed in the film in a state where the film is welded to the main body.

2. The manufacturing method according to claim 1, further comprising:
removing an unnecessary portion in the film after the molding.

3. The manufacturing method according to claim 1, wherein
the film includes a weld layer and a base film layer which have different melting points from each other, and
in the welding, the weld layer and a rib molded on a peripheral portion of an opening of the depressed portion are heated to be fused with each other.

4. The manufacturing method according to claim 3, wherein
the rib is molded in a circular ring shape on the peripheral edge of the depressed portion,
the plate member has a circular plate shape, and
in the welding and the molding, a center of a ring formed by the rib disposed in a ring shape and a center of the plate member coincide on the same axis.

5. The manufacturing method according to claim 3, wherein
the weld layer and the rib contain polypropylene.

6. The manufacturing method according to claim 3, wherein
the base film layer is laminated on the weld layer,
the weld layer includes a cast polypropylene film, and
the base film layer includes an oriented polyethylene terephthalate film.

7. The manufacturing method according to claim 6, wherein
the base film layer further contains aluminum or silica deposited on the oriented polyethylene terephthalate film.

8. The manufacturing method according to claim 1, wherein
in the molding, part of the film moves from a weld portion between the film and the main body by 0.9 mm in a direction opposite to the depressed portion.

9. The manufacturing method according to claim 1, further comprising:
pushing a region between a weld portion with the main body in the film and the plate member in a direction of the depressed portion, between the welding and the molding.

10. The manufacturing method according to claim 9, wherein
in the molding, part of the film moves from the weld portion between the film and the main body by 1.8 mm in a direction opposite to the depressed portion.

11. The manufacturing method according to claim 1, wherein
the elastic body is a spring configured to bias the depressed portion and the plate member in directions away from each other.

12. The manufacturing method according to claim 1, wherein
the pressure adjustment mechanism is disposed in an inkjet printing apparatus to adjust a pressure of an ink to be supplied to a printing head.

13. The manufacturing method according to claim 12, wherein
the main body includes:
a valve chamber molded inside the main body;
a supply flow path capable of supplying the liquid to the valve chamber;
a connection flow path connecting the valve chamber and the depressed portion;
a valve mechanism disposed in the valve chamber and capable of opening and closing the connection flow path; and
a discharge flow path capable of discharging the liquid from the depressed portion.

14. A pressure adjustment mechanism configured to adjust a pressure of a liquid, comprising:
a main body having a depressed portion capable of storing the liquid and a rib protruding from a peripheral portion of the depressed portion;
a film having flexibility and including a first layer which is extendable and a second layer which is difficult to extend, where the second layer is welded to the rib in such a manner as to close the depressed portion; and
an elastic body disposed in the depressed portion and configured to bias a plate member fixed to the film in a direction away from the depressed portion, wherein
the film has a deflected portion surrounding the plate member, between the plate member and a weld portion in which the second layer and the rib are welded.

15. A printing head mechanism comprising:
a pressure adjustment mechanism configured to adjust a pressure of a liquid, including a main body having a depressed portion capable of storing the liquid and a rib protruding from a peripheral portion of the depressed portion, a film having flexibility and including a first layer which is extendable and a second layer which is difficult to extend, where the second layer is welded to the rib in such a manner as to close the depressed portion, and an elastic body disposed in the depressed portion and configured to bias a plate member fixed to the film in a direction away from the depressed portion; and
a printing head capable of ejecting the liquid the pressure of which is adjusted by the pressure adjustment mechanism to a printing medium, wherein
the film has a deflected portion surrounding the plate member, between the plate member and a weld portion in which the second layer and the rib are welded.
